(19) United States
(12) Patent Application Publication
(10) Pub. No.: US 2025/0348930 A1
(43) Pub. Date: Nov. 13, 2025

(54) CHECKOUT APPROVAL THROUGH FEATURE FLAG TRACKING AND GUIDED USER DATA FLOWS

(71) Applicant: PAYPAL, INC., San Jose, CA (US)

(72) Inventors: Kei Sasaki, Tokyo (JP); Chunyi Yeh, Kawasaki (JP); Junta Mitsugi, Yokohama (JP)

(21) Appl. No.: 19/002,159

(22) Filed: Dec. 26, 2024

Related U.S. Application Data
(60) Provisional application No. 63/646,623, filed on May 13, 2024.

(51) Int. Cl. G06Q 40/03

(52) U.S. Cl. CPC G06Q 40/03

(57) ABSTRACT

There are provided systems and methods for checkout approval through feature flag tracking and guided user data flows. An online transaction processor may provide account establishment and/or know your customer (KYC) data verification at merchant checkout through use of different account processes and feature flags for mobile applications. A user may utilize their mobile device to scan a code at the merchant checkout, which may cause loading of an interface in the mobile application and a corresponding feature flag. Based on whether the user has previously used the application and/or has an account with the transaction processor, the user may be guided to a processing flow for data input, processing, and verification. The data may include KYC data, which may be used to perform a risk assessment of the user and determine a spending limit extendable to the user.

### CROSS REFERENCE TO RELATED APPLICATION

This application claims priority to U.S. Patent Application No. 63/646,623, filed May 13, 2024, all of which is incorporated by reference herein in its entirety.

### TECHNICAL FIELD

The present application generally relates to mobile interfaces and data processing, and, more particularly, to providing guided and streamlined flows for user data verifications and checkout interfaces.

### BACKGROUND

Users may utilize online transaction processors for processing payments between different entities through device applications and digital accounts. Further, these online transaction processors may also provide payment options, loans, and/or extensions for in-person transaction processing and use at merchant locations. When extending payment options and spending limits via one or more software applications, users may receive a spending limit and/or may be capable of utilizing a spending balance, real funds, or virtual funds linked to a digital account. Some balances may be associated with pay advances, installment loans, or other credit loans in anticipation of future earnings, wages, or income.

When visiting merchant locations, users may desire to utilize these services and obtain such spending limits and balances to make purchases at the merchant locations. However, obtaining such limits and balances requires significant data entry and processing, where a user may be required to identify and navigate to a specific data processing flow on a computing device and go through a lengthy data entry process. These processes are not streamlined for the specific merchant, user request, and/or user's account and data. Moreover, since an account with a transaction processor extending such limits and balances is required, the user may not be capable of accessing such flows and viewing an available or statement balance for a periodic cycle, a limit or amount of used balance, and/or other available funds. Thus, online transaction processors may encounter difficulties in guiding users to specific data processing flows and further tailoring those flows to provide a streamlined and efficient user experience when accessing limits and balances with a merchant and merchant checkout process. As such, it is desirable for transaction processor to provide automated processes to direct users to specific data processing flows that reduce required user inputs and provide faster and more efficient navigation to merchant checkout processes with available spending limits for each user.

### BRIEF DESCRIPTION OF THE DRAWINGS

FIG. 1 is a block diagram of a networked system suitable for implementing the processes described herein, according to an embodiment;

FIG. 2 is an exemplary diagram of mobile device and mobile device application interacting with a software development kit and server for guided user data flows based on feature flags, accounts, and merchant checkouts, according to an embodiment;

FIG. 3 is a flowchart of an exemplary process for checkout approval through feature flag tracking and guided user data flows, according to an embodiment;

FIGS. 4A-4AO are exemplary diagrams and user interfaces that provide guided user data flows for spending limits and merchant checkout processes based on feature flag tracking from discovery interactions and checkout entry points, according to embodiments; and

FIG. 5 is a block diagram of a computer system suitable for implementing one or more components in FIG. 1, according to an embodiment.

Embodiments of the present disclosure and their advantages are best understood by referring to the detailed description that follows. It should be appreciated that like reference numerals are used to identify like elements illustrated in one or more of the figures, wherein showings therein are for purposes of illustrating embodiments of the present disclosure and not for purposes of limiting the same.

### DETAILED DESCRIPTION

Provided are methods utilized for checkout approval through feature flag tracking and guided user data flows. Systems suitable for practicing methods of the present disclosure are also provided.

A user may utilize a digital account to process payments through an electronic card or a transaction network associated with a backend transaction processor or other entity on the network. The digital account of the user may be used for transaction processing at merchant locations via an online transaction processor, such as a payment service provider (e.g., Paidy® or PayPal®), which may provide electronic transaction processing services to users through the account and one or more websites and/or applications of the online transaction processor or a merchant. Initially, the user may request that a balance, such as a spending limit, be provided to the user when the user discovers or enters a merchant checkout process for offline purchasing (e.g., purchases at a merchant location). When interacting with specific merchants and merchant checkout processes, the digital account may be established with and/or linked to a spending and/or credit limit, balance, or value available for use with the digital account and the specific merchant. The online transaction processor may include an integration with the electronic card network that allows for data exchange and communications between the two networks. The user and/or the online transaction processor may establish one or more spending limits on the digital account based on the merchant, the merchant checkout process or experience, and the user's data.

For example, a transaction processing limit and/or spending limit may be determined and provided by the online transaction processor through a mobile application on a mobile device of the user when the user discovers and/or enters the merchant checkout process through one or more entry points or interactions (e.g., selecting a link, navigating to a website, scanning a quick response (QR) code or the like in a merchant pamphlet or leaflet, etc.). A software development kit (SDK) on the user's mobile device may fetch a feature flag, or an enabled feature that executes code and displays an interface and/or data through an interface, that is associated with a merchant and/or spending limit request process for the transaction processor. The feature flag may also correspond to a referral flag identifying the request by the merchant to the transaction processor for spending limit determination and extension, which may correspond to a referral of the user to the transaction processor.

The feature flag may be associated with data, such as deeplink data, that may also be retrieved from a server and includes a status, object, parameters, and/or executable code to direct or guide the application to a specific flow for user data entry and acquisition. The user data may be associated with know your customer (KYC) data that is used by a risk engine to determine the spending limit for the user. The feature flag may accompany the user and mobile device through the processing flow so that a risk decision on the spending limit (e.g., whether to extend, how much, etc.) may be based on the feature flag, merchant, merchant checkout process and/or items/services, user data, and the like. Further, after a decision on the spending limit has been determined, the feature flag may be used to load merchant-specific, including location, branch, item/service, etc. specific, checkout interfaces and options. Thereafter, as the user utilizes the digital account to process transactions, the online transaction processor may utilize the extended spending limit or balance specifically for the merchant, merchant location, and/or items/services corresponding to the merchant checkout process.

In this regard, a user may desire to process a purchase of one or more items or services with a merchant and/or at a merchant location via a software application and/or digital account that provides values, credit, or other funds to the user through an online transaction processor and/or electronic card network. Selection of one or more items in an in-person transaction at a physical merchant location or other virtual or remote transactions may require a payment instrument from the user for electronic transaction processing, which may include spending limits and balances extended to a user that are repayable in installments or over time periods at regular or scheduled times. A user may pay for one or more transactions using a digital wallet or other account with an online service provider or other transaction processor (e.g., Paidy® or PayPal®), as well as the digital account (e.g., through proffering the card and having the card data read or by entering card details and/or account numbers). An account and/or corresponding digital account with a service provider may be established by providing account details, such as a login, password (or other authentication credential, such as a biometric fingerprint, retinal scan, etc.), and other account creation details. The account creation details may request user data to establish the account, such as personal information for a user, business or merchant information for an entity, or other types of identification information including a name, address, and/or other information. Such information may correspond to KYC information used to verify a user and/or user's identity, as well as perform risk analysis and underwriting decisions for credit, installment loans, pay advances, or the like for extendable balances and spending limits.

The user data requested may also correspond to financial information, including digital account (e.g., credit/debit card) information, bank account information, gift card information, benefits/incentives, and/or financial investments, when processing transactions with merchants and/or other users or entities. Account creation may also be used to establish account funds and/or values, such as by transferring money into the account and/or establishing a spending or credit limit and corresponding value that is available to the account and/or card. The online payment provider may provide digital wallet services, which may offer financial services to send, store, and receive money, process financial instruments, and/or provide transaction histories, including tokenization of digital wallet data for transaction processing. The application or website of the service provider, such as Paidy® or PayPal® or other online payment provider, may provide payments and the other transaction processing services. The digital account may be utilized through one or more mobile applications for mobile devices or other software applications.

In order to pay for the transaction (e.g., a transfer or payment to another user, merchant, or other entity), the user may provide the digital account or funding source information or may login to an account with the service provider through authentication information in a software application. A payment may then be issued to the other party to the transaction and transaction information may be stored with the digital wallet or account. In this regard, a digital token or other data may authorize and/or authenticate the user for their digital wallet use and/or a payment instrument in the digital wallet, which may be transmitted to another party (e.g., the agent and/or merchant) for payment processing. In some embodiments, the account and/or digital wallet may be linked to the user's device or application and a checkout process may be authorized by the user, where selection of the account or other data may automatically initiate the process to purchase the item using the account and/or digital wallet.

To initially establish a digital account and/or spending limit with a preexisting digital account, a user may be required to go through a KYC process and verification, which may include running a risk assessment of the user for underwriting and/or risk management of extendable credit, installment loans, advancements, and the like. This may include establishing a “Plus” account or a preferred and/or verified account that has the corresponding KYC check and risk analysis performed. However, this can be a lengthy and time-consuming process, which may also require many user inputs and for users to locate and navigate to the correct processing flows and interfaces. To streamline this process and make data input and processing faster and more efficient, the transaction processor may provide processes with an application on a mobile device to direct users to specific user data flows for processing of KYC data depending on the merchant and/or checkout entry point, as well as interactions regarding discovery of the merchant/checkout (e.g., how the user was routed to the merchant's checkout process and flow).

For example, a user may enter a merchant checkout process through different entry points, which each may be associated with a discovery interaction or other action taken by the user that interacts with the merchant and/or the merchant's checkout process. In this regard, the entry points may include a weblink that may direct a desktop/laptop or mobile device to a specific website and/or open a native software application resident on the device. The user may also scan or capture a QR code or other displayable code or data that includes embedded and/or encoded data that directs the device to a particular website, interface, or the like. When discovering and/or interacting with this entry point, the user's device may load a feature flag via a website or interface, where the feature flag is associated with a referral by the merchant to the transaction processor for account establishment and/or upgrade to the “Plus” or KYC verified version, thereby determining and providing a spending limit specific to the merchant and/or sub-merchant (e.g., certain merchant location for a chain of merchants) that the user is interested in and interacting with when entering the checkout process and flow.

The feature flag may be loaded by an SDK of an application on the user's mobile or other computing device. In this regard, after initially selecting the link or capturing the QR code, the user may be prompted to open an application or the application may automatically be opened, where the application may be provided by the transaction processor. If not already installed, the user's device may be directed to an application store or download link to the application. Once downloaded, installed, and/or opened, the application may then load the feature flag, which may include information for the spending limit request and KYC verification process. If the user has an account with the transaction processor, the user may be asked to login or automatically logged in if applicable to the application and/or user preferences. If not, the user may be required to set up an account by entering an account establishment flow, as described herein.

With the feature flag, the SDK may also retrieve and/or receive data, such as deeplink data, that may identify that the user entered the KYC process and verification flow, as well as requested the spending limit and merchant checkout, through a particular entry point and/or discovery interaction. The deeplink data may include a status, object, parameters, and/or executable code that may cause the application to load a specific KYC process. Thus, the SDK of application may utilize the fetched and loaded feature flag and/or deeplink data to then direct the user to a KYC process, where the user data requested from the user may correspond to a subset of standardized or all KYC data normally required to perform a KYC check and credit/underwriting decision for a spending limit. Once the user enters the data, the data may be sent to the transaction processor for risk decisioning.

The transaction processor may then execute a risk engine to determine a decision on risk and available underwriting, credit, or loans extendable to the user. The risk engine may further process the feature flag and referral for the merchant so that the decision is also specific to the merchant and for the items/services purchasable from the merchant. After determination of the decision, the transaction processor may provide the decision to the user's device, which may open, load, navigate to, and/or transition to a checkout interface for the merchant checkout process. This checkout interface may be merchant specific, as well as specific to the merchant's location, branch, or specific items/services available from the merchant that correspond to the user's initial checkout process entry point and discovery.

As such, once the digital account is opened, such as after a credit and/or debit card is opened, established, and/or linked to the user's digital account, the user may receive an available balance that may be utilized by the user. This may correspond to a real or virtual asset or value and may be a revolving credit limit extended to the user. In this regard, the user may utilize a mobile and/or resident software application on a computing device and/or a website to receive and/or view one or more spending limits and/or transaction processing limits that may be available for use with the merchant and for offline and other checkouts and purchases with the merchant. These interfaces may allow the user to view a maximum spending limit that may be extended based on one or more rules, regulations, and/or budgets that are associated with the user.

Thereafter, a transaction may be processed using the digital account(s), which may generate and process transaction data for the transaction on a digital network. The transaction data may further include information, such as one or more items, item costs (e.g., itemizations) and/or a total cost, a transaction time, a corresponding merchant or merchant identifier, other users involved in the transaction, a transaction location, an MCC identifying a particular category for each transaction, and/or other transaction data. The online transaction processor may provide electronic transaction processing services used to process the transaction using the transaction data and/or card data. However, in other embodiments, in order to receive this data, the online transaction processor may be required to interface with a backend card processor and/or electronic card or transaction network that transmits, receives, and/or processes the transaction data based on associated payment instrument data, such as a payment card, bank account, or the like. In this regard, the online transaction processor may utilize an application programming interface (API) to communicate and integrate with one or more APIs of the electronic card network. This allows the online transaction processor to detect, receive, and process the transaction data, for example, by setting and/or enforcing spending limits on transactions that are processed on the electronic payment network. Thereafter, the transaction data may be detected and/or transmitted to the online transaction processor via one or more APIs. This may include receiving and processing the data in real-time, such as when the transactions occur in order to enforce spending limits and other electronic transaction processing limits on the digital account when used for electronic transaction processing on one or more networks.

When the transaction data for a transaction is received by the online transaction processor when the transaction is requested to be processed, the transaction data may then be analyzed to determine whether the transaction complies with or violates the limit(s) established in the application for the account. This may be done by listening to card reading and/or scanning events and receiving corresponding transaction information, or by monitoring incoming communications from the electronic card network, merchants, point-of-sale (POS) devices, and the like, as well as identifying electronic transaction payments requested through a digital account. If the transaction complies with the limit, then the online transaction processor may approve the transaction or allow the transaction to be approved on the electronic card network (e.g., by not declining the transaction or requesting the electronic card network and/or backend credit card processing system to decline the transaction). However, if the transaction violates the limit or otherwise does not comply with the limit (e.g., if the transaction amount causes the balance of the digital account and/or digital account to exceed the limit balance cap), then the online transaction processor may decline the transaction by refusing to process the transaction and/or requesting that the electronic card network and/or backed credit card processing system reject or decline the transaction.

In this manner, an application and corresponding transaction processor may efficiently guide users to correct data processing flows, thereby requesting specific KYC data necessary for corresponding determinations of spending limits for certain merchants. This may reduce the manual inputs by users and required navigations through different webpages and/or interfaces. Further, by performing more streamlined and optimized user data flows for KYC checks and data, service providers may more efficiently and accurately execute risk engines and perform risk decisioning, resulting in better risk decisions when computing merchant-specific spending limits and the like. As such, the applications and decisioning platforms of an online transaction processor may be improved for handling of merchant-specific checkout flows and offline entry points to merchant checkouts.

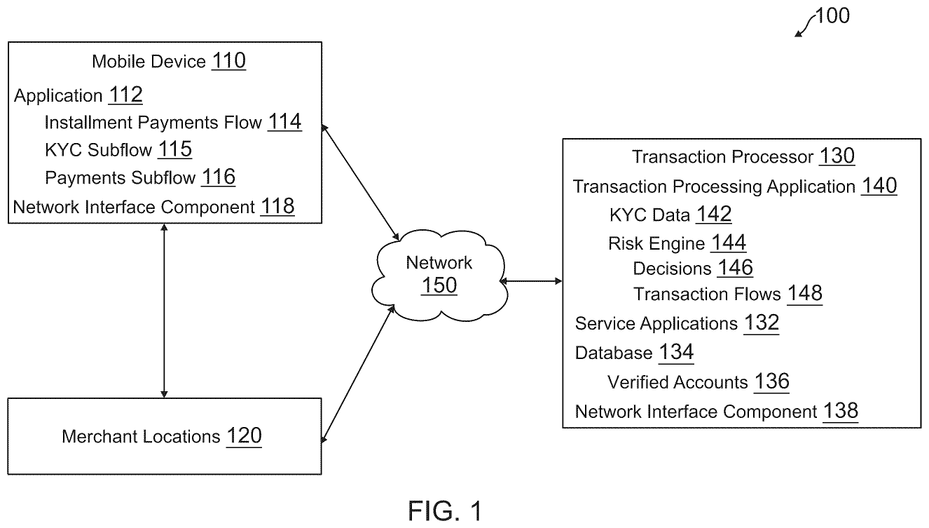

FIG. 1 is a block diagram of a networked system 100 suitable for implementing the processes described herein, according to an embodiment. As shown, system 100 may comprise or implement a plurality of devices, servers, and/or software components that operate to perform various methodologies in accordance with the described embodiments. Exemplary devices and servers may include device, stand-alone, and enterprise-class servers, operating an OS such as a MICROSOFT® OS, a UNIX® OS, a LINUX® OS, or another suitable device and/or server-based OS. It can be appreciated that the devices and/or servers illustrated in FIG. 1 may be deployed in other ways and that the operations performed and/or the services provided by such devices and/or servers may be combined or separated for a given embodiment and may be performed by a greater number or fewer number of devices and/or servers. One or more devices and/or servers may be operated and/or maintained by the same or different entities.

System 100 includes a mobile device 110,, and a transaction processor 130 in communication over a network 150. Mobile device 110 may be used to establish a transaction and process a payment for the transaction using an account managed by mobile device 110. In this regard, mobile device 110 may interact with merchant locations 120 to set spending limits or balances that may be available to process transactions and complete checkouts with a corresponding merchant. Transaction processor 130 may receive user data from streamlined user data flows and determine the spending limits, which may be provided back to mobile device 110 for transaction processing.

Mobile device 110, merchant locations 120, and transaction processor 130 may each include one or more processors, memories, and other appropriate components for executing instructions such as program code and/or data stored on one or more computer readable mediums to implement the various applications, data, and steps described herein. For example, such instructions may be stored in one or more computer readable media such as memories or data storage devices internal and/or external to various components of system 100, and/or accessible over network 150.

Mobile device 110 may be implemented using any appropriate hardware and software configured for wired and/or wireless communication with merchant locations 120 and/or transaction processor 130 for processing a transaction based on one or more spending limits. Mobile device 110 may correspond to a user that makes payments through an executable software application. In various embodiments, mobile device 110 may be implemented as a personal computer (PC), a smart phone, laptop/tablet computer, wristwatch with appropriate computer hardware resources, other type of wearable computing device, and/or other types of computing devices capable of transmitting and/or receiving data. Although only one computing device is shown, a plurality of computing devices may function similarly.

Mobile device 110 of FIG. 1 contains an application 112 and a network interface component 118. Application 112 may correspond to executable processes, procedures, and/or applications with associated hardware. In other embodiments, mobile device 110 may include additional or different modules having specialized hardware and/or software as required.

Application 112 may correspond to one or more processes to execute software modules and associated components of mobile device 110 to provide features, services, and other operations for a user over network 150, which may include accessing and utilizing computing services provided by transaction processor 130. In this regard, application 112 may correspond to specialized software utilized by a user of mobile device 110 that may be used to access a website or application (e.g., mobile application, rich Internet application, or resident software application) that may display one or more user interfaces that allow for interaction with the computing services of transaction processor 130. In various embodiments, application 112 may correspond to a general browser application configured to retrieve, present, and communicate information over the Internet (e.g., utilize resources on the World Wide Web) or a private network. For example, application 112 may provide a web browser, which may send and receive information over network 150, including retrieving website information, presenting the website information to the user, and/or communicating information to the website. However, in other embodiments, application 112 may include a dedicated application of transaction processor 130 or other entity.

Application 112 may be associated with account information, user financial information, and/or transaction histories, which may be utilized through transaction processing and/or payment services including those associated with spending limits. However, in further embodiments, different services may also be provided via application 112, including social networking, media posting or sharing, microblogging, data browsing and searching, online shopping, and other services available through transaction processor 130. Thus, application 112 may also correspond to different service applications and the like.

When utilizing application 112 with transaction processor 130, application 112 may request a spending limit through an installment payments flow 114, such as to process a payment request and/or receive a spending limit request for a merchant checkout process. Installment payments flow 114 may correspond to a data processing flow of application 112 to request, establish, and/or adjust a spending limitation via one or more application icons, interfaces, and/or interactions with such displayable data. Installment payments flow 114 may also include a payment request with one or more merchants, which may individually be merchant specific for a spending limit or may be for a spending limit available over multiple merchants and/or merchant locations. Installment payments flow 114 may be used with a user account of the user, and installment payments flow 114 may have a corresponding user input for the spending limit that may be processed by transaction processor 130, such as through a KYC subflow 115.

In this regard, application 112 may include an SDK provided by transaction processor 130 and/or another service provider that includes application operations, code, routines/subroutines, APIs and/or API calls, and the like that may be used to interface with a backend to obtain feature flags or referral flags for a merchant referral to transaction processor 130 for the spending limit. Such feature flags may be retrieved based on mobile device 110 interacting with merchant locations 120. With the feature flags, the SDK of application 112 may retrieve data, such as deeplink data, which may be used to open, direct to, guide to, or otherwise execute installment payments flow 114 in application 112. The deeplink data may also be used when directing application 112 to KYC subflow 115 and/or a payments subflow 116 during installment payments flow 114.

As such, installment payments flow 114 may be used to establish a spending limit, which may correspond to installment loans or payments that are due at regular intervals for repayment. However, other types of loans, credit, advancements, and the like may also be provided. To receive the spending limit, a KYC check of user data may be required by a risk analysis performed by transaction processor 130. As such, KYC subflow 115 may be utilized by the user on mobile device 110 to enter user data and perform the KYC check or other user data validation and/or verification. A result or decision of the risk assessment and analysis may be output, such as whether the spending limit is available and for how much, via application 112. Application 112 may then direct to a payments subflow 116 specific to the merchant and/or merchant locations 120 that was interacted with, which may include checkout and payment options for items/services available from the specific merchant and/or in an offline environment. As such, the merchant checkout process may be specifically designed and tailored in a checkout interface for payments subflow 116.

In various embodiments, mobile device 110 includes other applications as may be desired in particular embodiments to provide features to mobile device 110. For example, the other applications may include security applications for implementing client-side security features, programmatic client applications for interfacing with appropriate application programming interfaces (APIs) over network 150, or other types of applications. The other applications may also include email, texting, voice and IM applications that allow a user to send and receive emails, calls, texts, and other notifications through network 150. In various embodiments, the other applications may include financial applications, such as banking applications. Other applications may include social networking applications, media viewing, and/or merchant applications.

The other applications may also include other location detection applications, which may be used to determine a location for the user, such as a mapping, compass, and/or GPS application, which can include a specialized GPS receiver that determines location information for mobile device 110. The other applications may include device interface applications and other display modules that may receive input from the user and/or output information to the user. For example, the other applications may contain software programs, executable by a processor, including a graphical user interface (GUI) configured to provide an interface to the user. The other applications may therefore use devices of mobile device 110, such as display devices capable of displaying information to users and other output devices, including speakers.

Mobile device 110 may further include a database stored on a transitory and/or non-transitory memory of mobile device 110, which may store various applications and data and be utilized during execution of various modules of mobile device 110. The database may include, for example, identifiers such as operating system registry entries, cookies associated with application 112 and/or the other applications, identifiers associated with hardware of mobile device 110, or other appropriate identifiers, such as identifiers used for payment/user/device authentication or identification, which may be communicated as identifying the user/mobile device 110 to transaction processor 130.

Mobile device 110 includes at least one network interface component 118 adapted to communicate with transaction processor 130 and/or other devices and servers over network 150. In various embodiments, network interface component 118 may include a DSL (e.g., Digital Subscriber Line) modem, a PSTN (Public Switched Telephone Network) modem, an Ethernet device, a broadband device, a satellite device and/or various other types of wired and/or wireless network communication devices including microwave, radio frequency, infrared, Bluetooth, and near field communication devices.

Merchant locations 120 may be provided and/or maintained, for example, by a merchant or other entity that provides items for sale to users including merchants providing sales at merchant locations and/or through offline interactions. Merchant locations 120 may correspond to one or more physical and/or online merchant marketplaces, sales platforms, point-of-sale (POS) devices, websites, and/or online resources where a user may visit in order to shop for items. For example, merchant locations 120 may include one or more POS devices at physical merchant locations to process transactions. In this regard, merchant locations 120 may include a QR code or other capturable data that may direct mobile device 110 to a merchant checkout process and account establishment or verification upgrade process for receipt of a spending limit. However, merchant locations 120 may also provide, physically or through electronic communications, links and/or navigations to websites and/or applications for online accessible digital platforms, where a user may offer or be offered products, services, and other items for sale and users may browse items, select items for purchase, and engage in electronic transaction processing. Merchant locations 120 may therefore be associated with a merchant checkout process and user data flow that verifies user data to provide a “plus,” upgraded, or enhanced account and/or account experience that includes availability of a spending limit for merchant purchases.

Transaction processor 130 may be maintained, for example, by an online service provider, which may provide processes to provide account services and process payments, as well as establish spending limits on a digital account's usage of a balance. In this regard, transaction processor 130 includes one or more processing applications which may be configured to interact with mobile device 110, merchant locations 120, and/or another device/server to facilitate communications and transactions between users. Transaction processor 130 may be maintained by or include another type of platform or service provider, for example, a transaction processor such as Paidy® or PayPal®.

Transaction processor 130 includes a transaction processing application 140, service applications 132, a database 134, and a network interface component 138. Transaction processing application 140 and service applications 132 may correspond to executable processes, procedures, and/or applications with associated hardware. In other embodiments, transaction processor 130 may include additional or different modules having specialized hardware and/or software as required.

Transaction processing application 140 may correspond to one or more processes to execute modules and associated specialized hardware of transaction processor 130 to process a transaction for item(s) with mobile device 110 and merchant locations 120, which may be based on one or more transactions and spending limitations established with the user of mobile device 110. In this regard, transaction processing application 140 may correspond to specialized hardware and/or software used by a user associated with mobile device 110 to establish an account with transaction processing application 140 by providing personal and/or financial information to transaction processor 130 and selecting authentication credentials. In various embodiments, the financial information may include payment instrument information, such as account/card numbers and information. The account may be used to purchase items and/or transfer funds. The payment account may be accessed and/or used through a browser application and/or dedicated payment application. However, in other embodiments, a payment account may be generated by another online transaction processor or service provider and linked with transaction processor 130, such as through merchant locations 120. Transaction processing application 140 may be used to set spending limits on usage of a balance, credit limit, or other funds for a digital payment account. Transaction processing application 140 may process a payment and may provide a transaction history for transaction authorization, approval, or denial,

Transaction processing application 140 may correspond to an application, platform, and processing system of transaction processor 130 that may be utilized by end users, such as to perform electronic payments, transfers, and the like using one or more accounts and/or financial instruments. Transaction processing application 140 may also include or utilize different processors, engines, or models as required for an authentication, account setup and maintenance, electronic transaction processing, deposit and/or withdrawal, dispute resolution, and the like. Transaction processing application 140 may include one or more API integrations and/or interactions with an electronic payment network or other payment network in order to detect, receive, and monitor transaction data for compliance with spending limits. Thus, transaction processing application 140 may interact with the network through one or more API calls to APIs of transaction processing application 140 that interfaces with APIs of the electronic payment network. Transaction processing application 140 may determine transaction data for transactions processed on the network.

Transaction processing application 140 may receive the transaction data for transactions processed using the account accessible through mobile device 110 and/or merchant locations 120. Transaction processing application 140 may then determine spending limits set on usage of a balance, credit limit, and/or other funds available to the digital account of the user. Transaction processing application 140 may determine whether the transactions comply with the spending limit(s). If so, the transaction may be approved or authorized. However, if the transaction does not comply with the spending limit or exceeds the limit on electronic transaction processing and/or credit/balance limit, then transaction processing application 140 may be used to decline transaction processing or instruct a backend credit processor and/or merchant locations 120 to decline processing of the transaction.

In order to determine spending limits, KYC data 142 received from mobile device 110 based on use of and input to KYC subflow 115 may be processed by a risk engine 144. KYC data 142 may correspond to a set of data, such as a specific subset of standard KYC data used for risk analysis by risk engine 144 or other risk assessment processes, that may be selected for the specific merchant, checkout process, and/or spending limit determination. Risk engine 144 may then be used to generate outputs of decisions 146 based on KYC data 142, which may be used to provide spending limits to devices and users, such as via application 112 on mobile device 110 (e.g., in a checkout interface or other interface). In some embodiments, risk engine 144 may employ one or more AI engines and/or models, such as rules-based, ML, or neural network (NN) models and/or engines, which may be used for intelligent decision-making of spending limits. These may include rules-based engines that may process KYC data 142, as well as merchant, checkout, and/or item/service data, which may be used to determine spending limits. ML engines and/or other rule computation or AI engines may be trained and/or used for determination of spending limits. AI models may generally correspond to any artificial intelligence that performs decision-making, such as rules-based engines and the like. However, AI models may also include subcategories, including ML models and NN models that instead provide intelligent decision-making using algorithmic relationships. Generally, NN may include deep learning models and the like, and may correspond to a subset of ML models that attempt to mimic human thinking by utilizing an assortment of different algorithms to model data through different graphs of neurons, where neurons include nodes of data representations based on the algorithms that may be interconnected with different nodes. ML models may similarly utilize one or more of these mathematical models to generate branches, clusters, or other relationships between data.

When building ML models for machine learning engines, training data may be used to generate one or more classifiers and provide recommendations, predictions, or other outputs based on those classifications and an ML model. The training data may be used to determine input features for training predictive scores and/or outputs for spending limits. For example, NNs and ML models for risk engine 144 may include one or more layers, including an input layer, a hidden layer, and an output layer having one or more nodes, however, different layers may also be utilized. For example, as many hidden layers as necessary or appropriate may be utilized. Each node within a layer is connected to a node within an adjacent layer, where a set of input values may be used to generate one or more output scores or classifications. Within the input layer, each node may correspond to a distinct attribute or input data type that is used to train the models.

Thereafter, the hidden layer may be trained with these attributes and corresponding weights using an ML algorithm, computation, and/or technique. For example, each of the nodes in the hidden layer generates a representation, which may include a mathematical ML computation (or algorithm) that produces a value based on the input values of the input nodes. The ML algorithm may assign different weights to each of the data values received from the input nodes. The hidden layer nodes may include different algorithms and/or different weights assigned to the input data and may therefore produce a different value based on the input values. The values generated by the hidden layer nodes may be used by the output layer node to produce one or more output values for the ML models for machine learning engines that attempt to classify and/or provide an output for a predictive spending limit. Thus, when ML models for machine learning engines are used to perform a predictive analysis and output, the input may provide a corresponding output based on the classifications trained for ML models for machine learning engines.

ML models for machine learning engines may be trained by using training data. By providing training data to train ML models for machine learning engines, the nodes in the hidden layer may be trained (adjusted) such that an optimal output (e.g., a classification) is produced in the output layer based on the training data. By continuously providing different sets of training data and penalizing ML models for machine learning engines when the output of ML models for machine learning engines is incorrect, ML models for machine learning engines (and specifically, the representations of the nodes in the hidden layer) may be trained (adjusted) to improve its performance in data classification. Adjusting ML models for machine learning engines may include adjusting the weights associated with each node in the hidden layer. Thus, the training data may be used as input/output data sets that allow for ML models for machine learning engines to make classifications based on input attributes. The output classifications for an ML model trained for machine learning engines may be classifications used for spending limit determination. Thereafter, spending limits may be used with one or more transaction flows 148, which may allow for payment processing. For example, payments subflow 116 on mobile device 110 may be used to request processing of a transaction in a merchant checkout process and using an extending spending limit. Transaction flows 148 may then process the transaction using the transaction processing services of transaction processing application 140.

Service applications 132 may correspond to one or more processes to execute modules and associated specialized hardware of transaction processor 130 to provide services to customers, merchants, and/or other end users and entities of transaction processor 130. In this regard, service applications 132 may correspond to specialized hardware and/or software used by transaction processor 130 to providing computing services to users, which may include electronic transaction processing and/or other computing services using accounts provided by transaction processor 130. The digital accounts may be accessed and/or used through one or more instances of a web browser application and/or dedicated software application executed by mobile device 110 and engage in computing services provided by service applications 132. Computing services of service applications 132 may also or instead correspond to messaging, social networking, media posting or sharing, microblogging, data browsing and searching, online shopping, and other services available through transaction processor 130.

In various embodiments, service applications 132 may be desired in particular embodiments to provide features to transaction processor 130. For example, service applications 132 may include security applications for implementing server-side security features, programmatic client applications for interfacing with appropriate application programming interfaces (APIs) over network 150, or other types of applications. Service applications 132 may contain software programs, executable by a processor, including a graphical user interface (GUI), configured to provide an interface to the user when accessing transaction processor 130 via one or more of mobile device 110, where the user or other users may interact with the GUI to view and communicate information more easily. In various embodiments, service applications 132 may include additional connection and/or communication applications, which may be utilized to communicate information to over network 150.

Additionally, transaction processor 130 includes database 134. Database 134 may store various identifiers associated with mobile device 110. Database 134 may also store account data, including payment instruments and authentication credentials, as well as transaction processing histories and data for processed transactions. Database 134 may store received data associated with a user, such as transaction data and spending limits on electronic transaction processing. Further, database 134 may be used to store data for verified accounts 136, which may include those accounts having verified user data and/or extended spending limits and balances.

In various embodiments, transaction processor 130 includes at least one network interface component 138 adapted to communicate with mobile device 110 and/or another device/server for a merchant over network 150. In various embodiments, network interface component 138 may comprise a DSL (e.g., Digital Subscriber Line) modem, a PSTN (Public Switched Telephone Network) modem, an Ethernet device, a broadband device, a satellite device and/or various other types of wired and/or wireless network communication devices including microwave, radio frequency (RF), and infrared (IR) communication devices.

Network 150 may be implemented as a single network or a combination of multiple networks. For example, in various embodiments, network 150 may include the Internet or one or more intranets, landline networks, wireless networks, and/or other appropriate types of networks. Thus, network 150 may correspond to small scale communication networks, such as a private or local area network, or a larger scale network, such as a wide area network or the Internet, accessible by the various components of system 100.

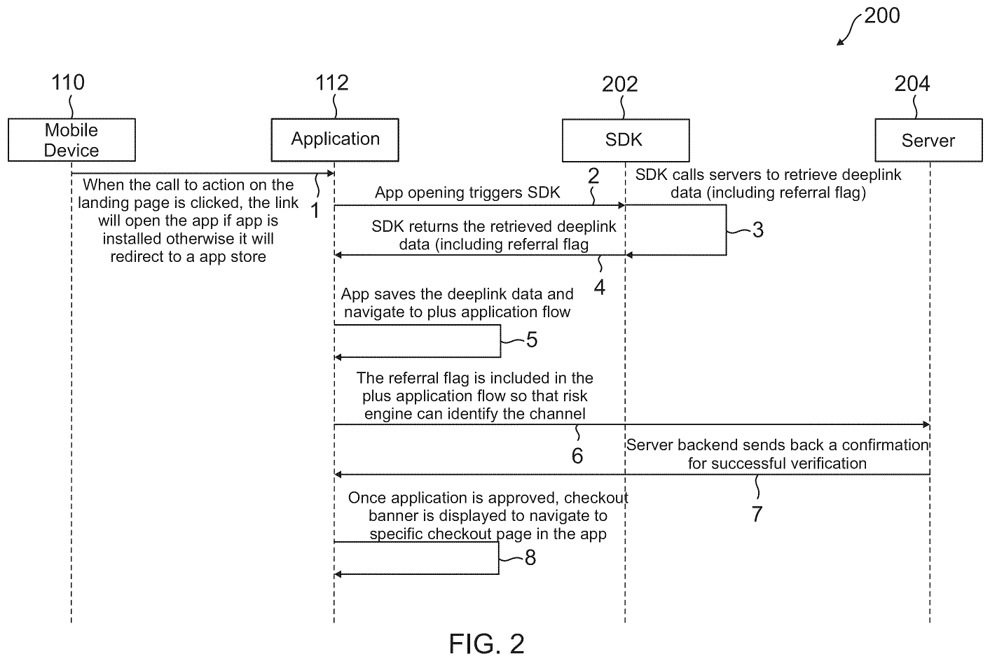

FIG. 2 is an exemplary diagram 200 of mobile device and mobile device application interacting with a software development kit and server for guided user data flows based on feature flags, accounts, and merchant checkouts, according to an embodiment. Diagram 200 corresponds to a set of calls and/or interactions executed with respect to the different components to facilitate directing mobile device 110, discussed in reference to system 100 of FIG. 1, to a guided user data flow for an account verification and/or upgrade that provides a spending limit usable with a merchant.

In diagram 200, interactions 1-8 may correspond to the API calls, requests, and/or other data exchanges or processing events that may occur to provide a merchant-specific spending limit and checkout process based on a guided user data flow to verify KYC data for a user in a merchant-specific manner. In this regard, at an interaction 1, a call to action, such as a request to interact with a web link, QR code, or the like, on a landing page or other merchant offer, promotion, leaflet, webpage, communication, or the like is viewed and selected. This selection may correspond to a discovery interaction whereby a user discovers a merchant and merchant checkout process for processing transactions with the merchant for items and/or services. As such, the call to action may be provided on or with a merchant checkout entry point that engages the user in a checkout process. Further, this entry point may be used to direct a user to a particular guided user data flow that verifies user data so the user may receive a spending balance for the checkout process.

As such, if the call to action is selected or interacted with, a link selected or embedding/encoded in a QR code or other displayable code opens application 112 or redirects the device to an application store to download application 112. Once downloaded and/or executed, at an interaction 2, the application opening of application 112 triggers use and execution of an SDK 202 of application 112. SDK 202 may correspond to software operations that cause application 112 to execute certain actions and calls. At an interaction 3, SDK 202 calls one or more servers to retrieve data, such as deeplink data, that includes a referral flag or other feature flag. This data may be retrieved by SDK 202 from a service provider's servers that provides SDK 202 for use in applications and stores the corresponding referral flags for merchants. At an interaction 4, the retrieved deeplink data including the referral flag is returned by SDK 202 to application 112. As such, application 112 may receive the deeplink data for use of and/or with one or more operations for account setup, spending limit verification, and/or checkout processing.

At an interaction 5, application 112 saves the deeplink data and, based on the data and/or the referral flag, navigates to a plus application flow. The plus application flow may correspond to a KYC or other user data flow that may request that the user provide personal data (e.g., personally identifiable information (PII)), financial data, and the like, which may be used to verify the user and/or the user's account so that a spending limit may be extended to the user. As such, the flow may require that the user login and/or establish an account and proceed through a KYC data check or the like to verify the user and provide a spending limit. Thus, at an interaction 6, the referral flag may be included with the data from the plus application flow that is provided to a server 204, such as a server of transaction processor 130, for verification and spending limit determination.

At an interaction 7, server 204 makes a determination on the verification based on the referral flag and the data received from the plus application flow and a confirmation for a successful verification may be sent back to application 112. The verification may be determined by a risk engine and based on KYC data processing and risk assessments. At an interaction 8, once application 112 is approved for the spending limit and transaction processing in the merchant checkout process, a checkout banner may be displayed to navigate application 112 to a specific checkout page or interface for the corresponding merchant. Thus, application 112 may display a merchant-specific checkout page and/or interface for the corresponding merchant and merchant checkout process.

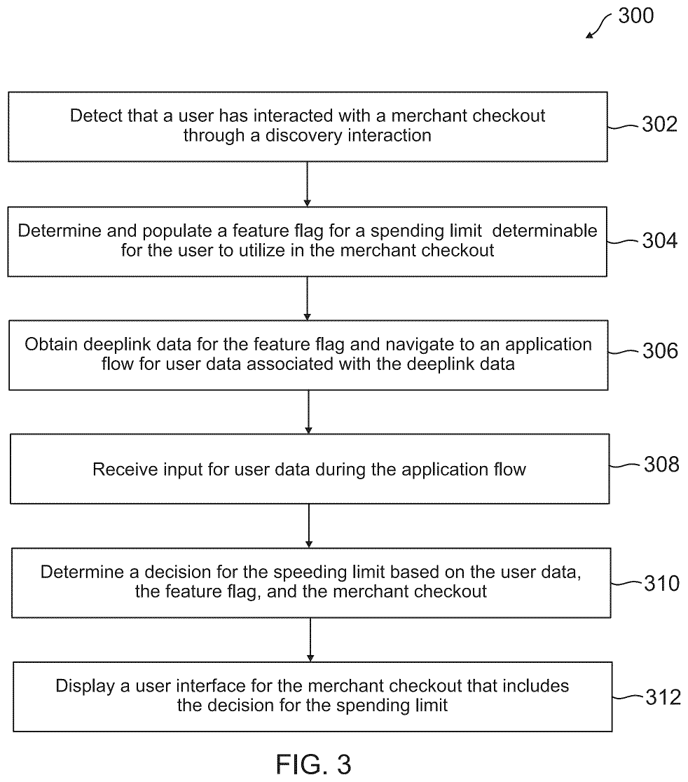

FIG. 3 is a flowchart 300 of an exemplary process for checkout approval through feature flag tracking and guided user data flows, according to an embodiment. Note that one or more steps, processes, and methods described herein of flowchart 300 may be omitted, performed in a different sequence, or combined as desired or appropriate.

At step 302 of flowchart 300, it is detected that a user has interacted with a merchant checkout through a discovery interaction. The interaction may correspond to a user scanning a displayable code, selecting a link, or other merchant checkout entry point where a user may enter and begin transaction processing and checkout, such as to purchase one or more items or services. Further, the discovery interaction may indicate that the user is requesting an available balance that may be used with the merchant and/or through the merchant checkout process. Such a request may be based on an available balance to the user (e.g., in a bank account or via another financial account or instrument including periodic salaries or pay periods), as well as credit, loans (e.g., installment loans), payment advancements (e.g., payday loans) or other limits that may be extended to the user. As such, an offer or extension for a spending limit may be provided to the user if the user establishes an account and/or verifies user data, such as KYC data required to provide the spending limit to the user for the merchant checkout. The discovery interaction may be performed by the user using a device, such as a mobile device when the user is at a merchant location of an merchant or the like.

At step 304, a feature flag for a spending limit determinable for the user to utilize in the merchant checkout is determined and populated, such as in a user interface of an application on a device of the user. Based on the user discovering and/or interacting with the merchant checkout and/or checkout process via their device, an application on the device of the user may load a feature flag, such as in a browser or other application. The feature flag may correspond to data loaded in an interface that notifies the user of the availability to request and/or receive a spending limit if the user engages in an account and user data verification, such as by signing up and/or upgrading to a verified account based on confirmed KYC data. The feature flag may be retrieved, fetched, or requested by an SDK of the application on the device of the user from a server that maintains different feature flags for different merchants and/or spending limit offers. As such, the application may be required to be installed and/or executed on the user's device, and download/installation may occur prior to determining and populating the feature flag in the application.

At step 306, deeplink data for the feature flag is obtained and an application flow for user data associated with the deeplink data is navigated to using the deeplink data. The deeplink data may be retrieved with the feature flag by the SDK and may include objects, parameters, code, and the like to direct the application on the device to a particular data processing flow that performs the account establishment and/or login, as well as the user data verification. For example, if the user does not yet have an account with the transaction processor extending the credit limit, the user may be asked to establish such an account. Once established and/or logged in to (e.g., with preexisting accounts), the application may direct the user to a user data flow on the device that requests particular user data used to verify the user and extend a spending limit, such as a subset of standardized KYC data used for risk analysis and/or underwriting. This allows the application flow to be particular to the merchant and/or merchant checkout process where the spending limit may be used, and therefore minimizes user inputs and navigations to find KYC check and validation flows, as well as excess KYC data input that may be unnecessary for the particular merchant, checkout, and/or spending limit.

At step 308, input for user data is received during the application flow. The user data may include user financial data, historical payment and/or repayment data, credit worthiness, and the like. As such, the user data may include KYC data input to the application flow based on specific requests for the data. These requests may be based on the merchant and/or checkout process, including the items/services available from the merchant and a merchant location, branch, sub-merchant, or the like that may more particularly narrow the checkout process and items/services.

At step 310, a decision for the spending limit is determined based on the user data, the feature flag, and the merchant checkout. An AI risk engine may include one or more rules-based and/or ML-based models for the engine, which may provide predictive output and determination of available balances, upcoming balances, and/or credit limits that may be available to the user. Using the user data and the merchant data, a spending limit may be calculated and/or a risk or underwriting score or value may be provided. This may allow for determination of an amount or maximum balance for a spending limit, which the user may utilize to process transaction via the merchant checkout process.

At step 312, a user interface for the merchant checkout that includes the decision for the spending limit is displayed, such as in an application interface of an application on a device of the user. The spending limit may be updated in the application such that the user may view one or more interface elements, options, icons, and/or user input preferences the spending limit. Transmission of the spending limit may occur while the user is at the merchant location and/or engaged in the merchant checkout process so that the user may view items/services available for purchase from the merchant and apply all or a portion of the spending limit to such purchases.

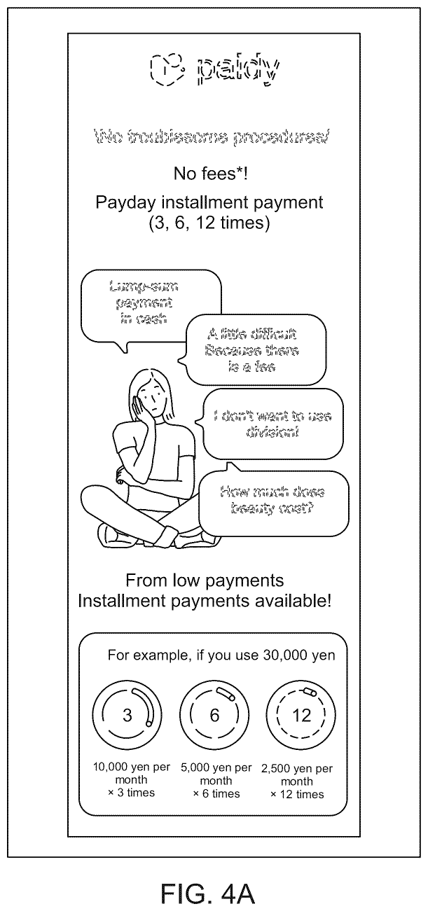

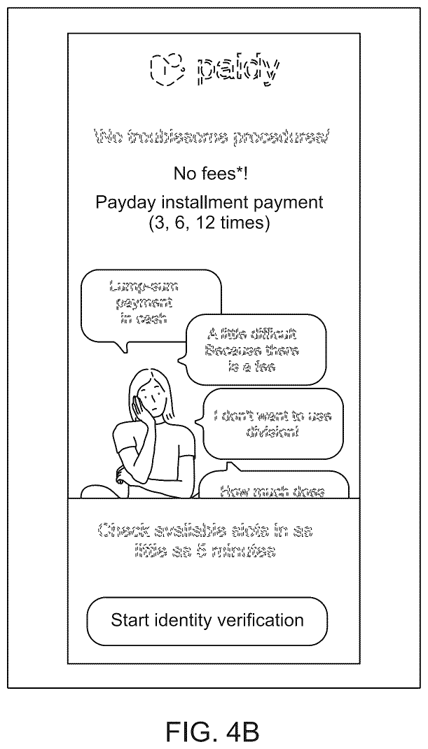

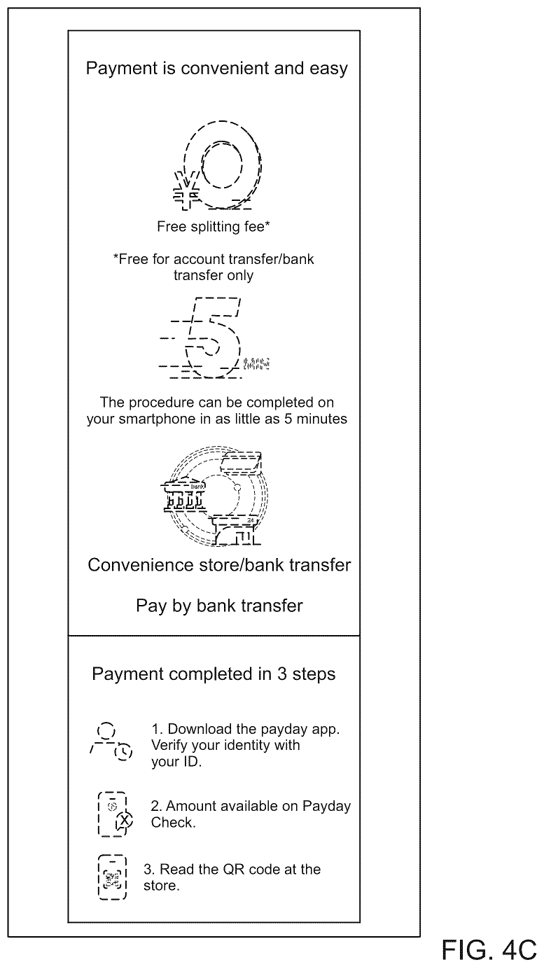

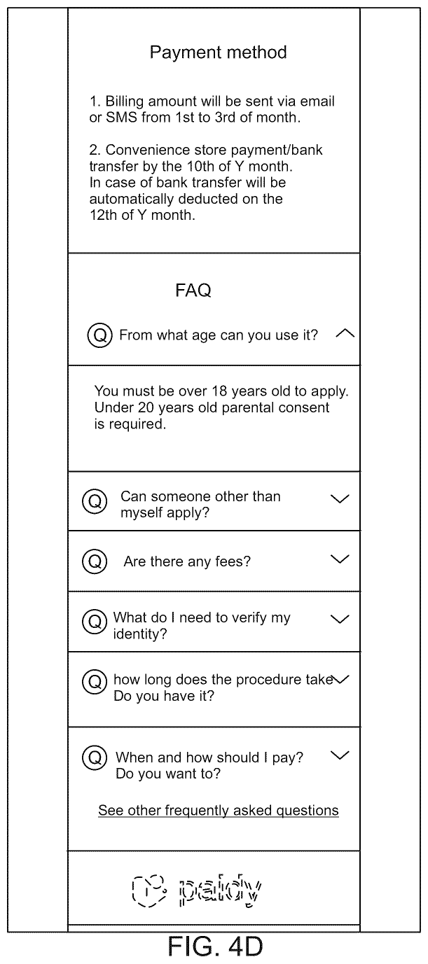

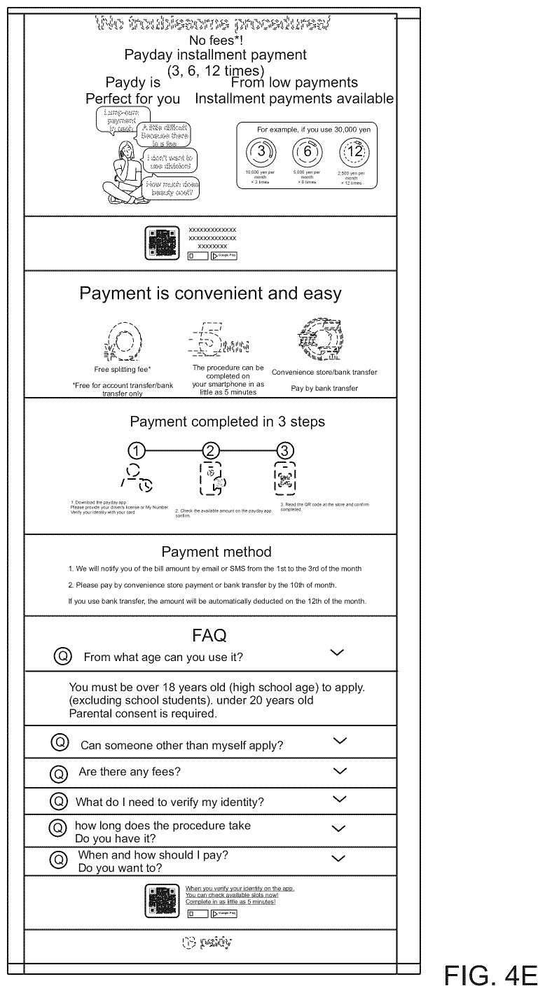

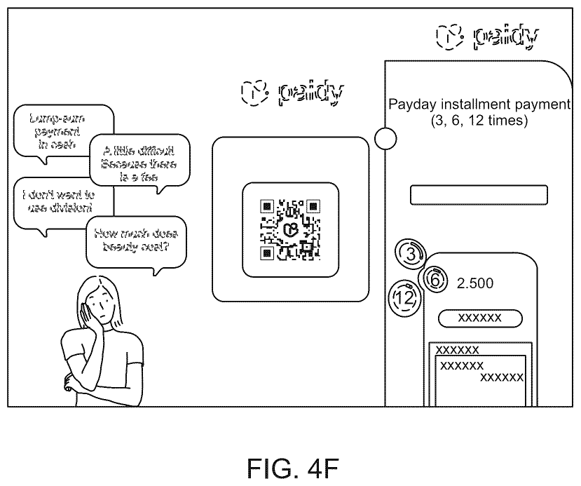

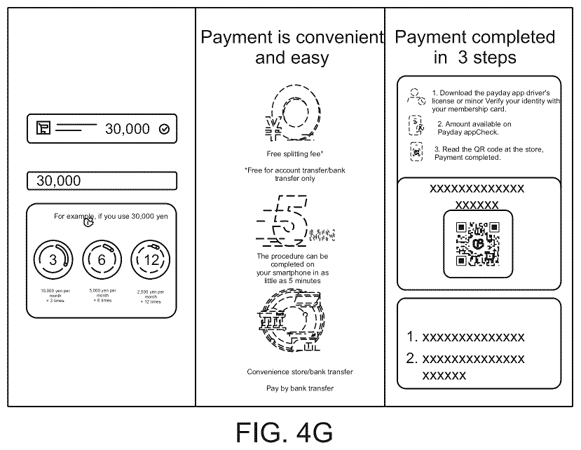

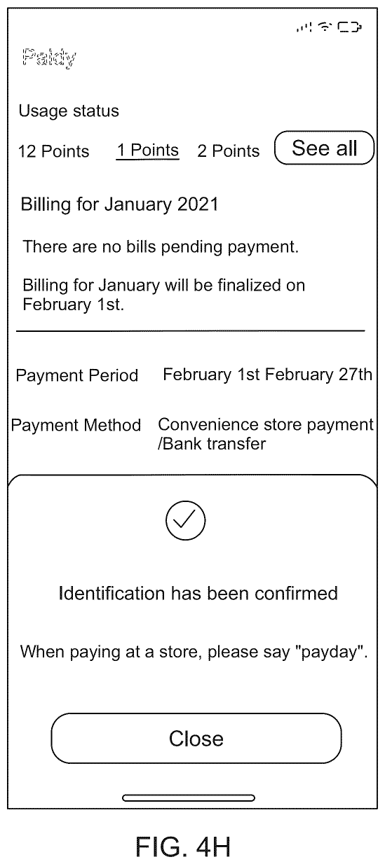

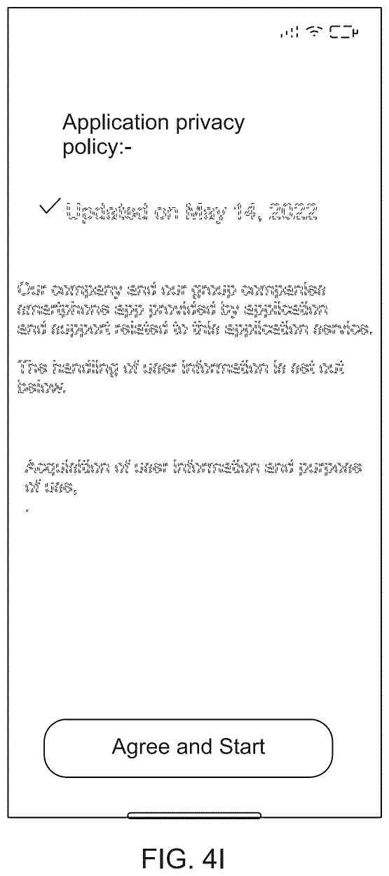

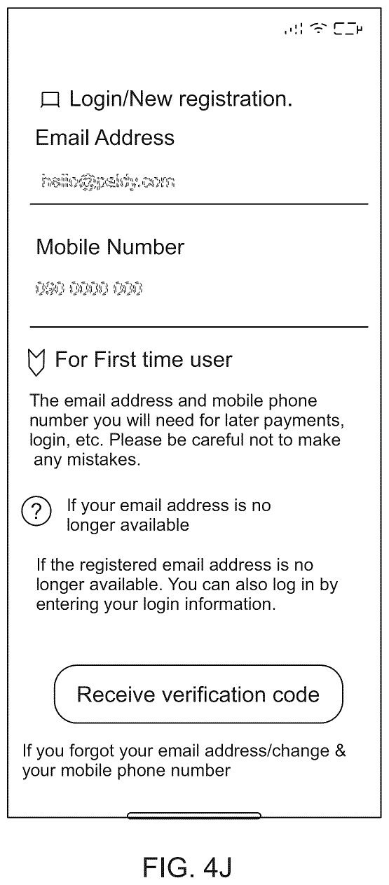

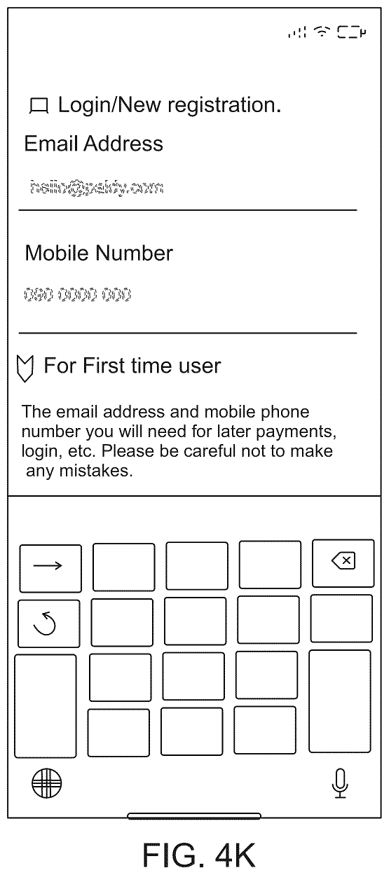

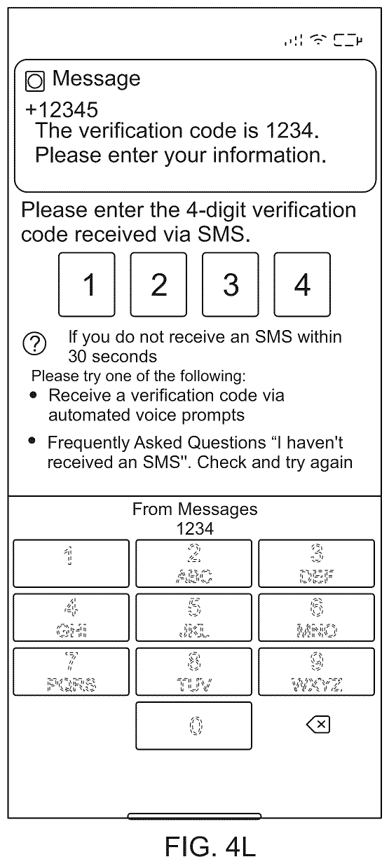

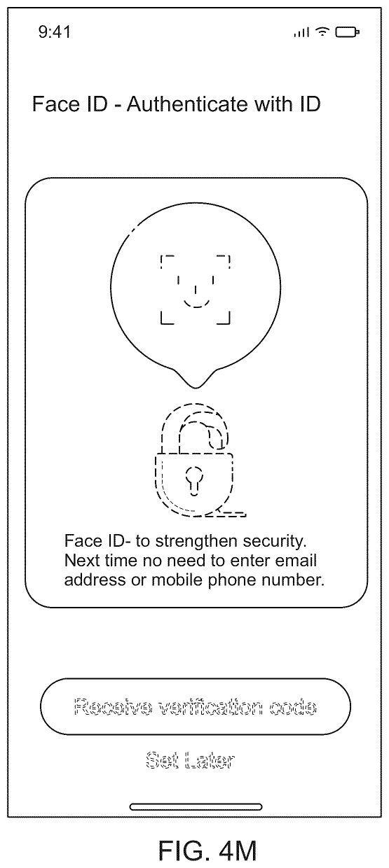

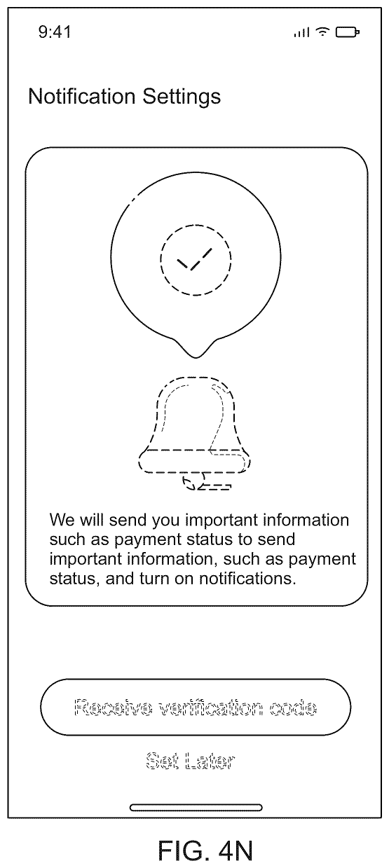

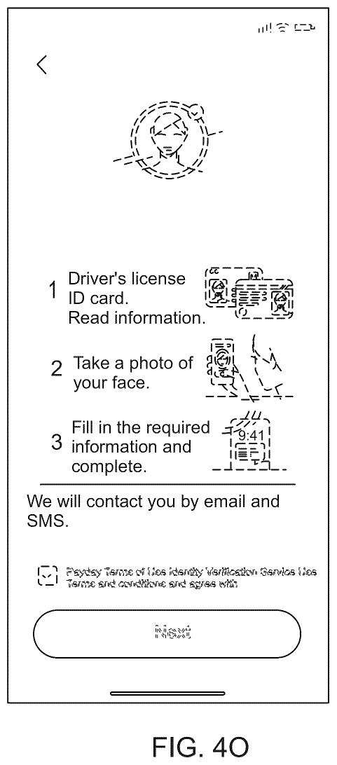

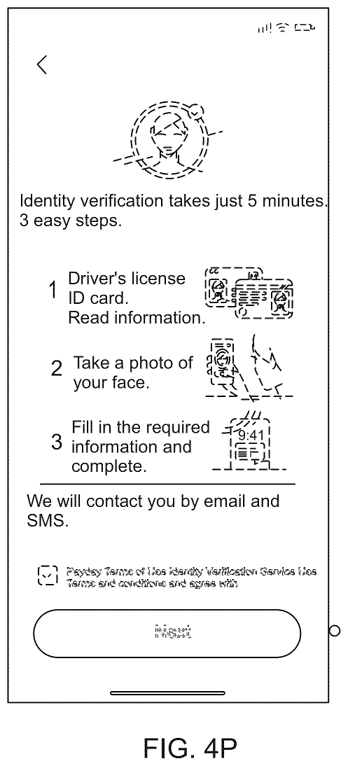

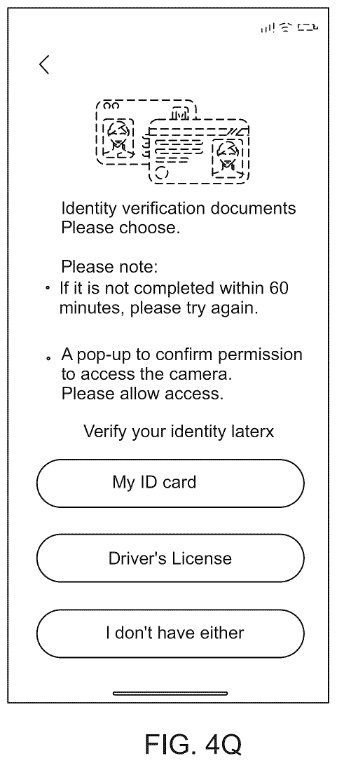

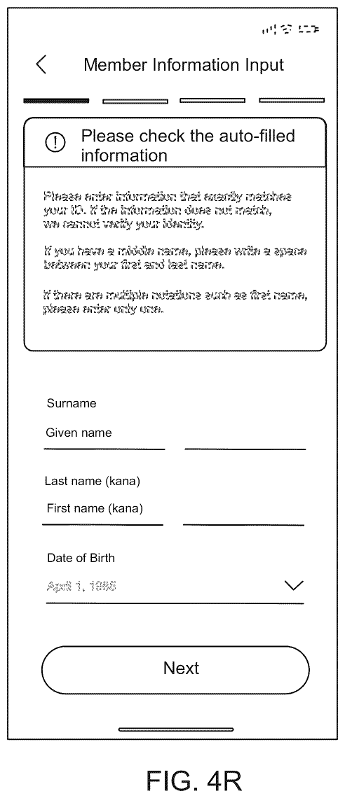

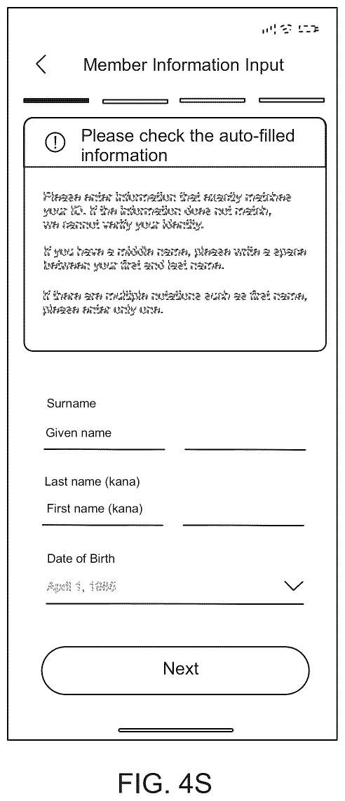

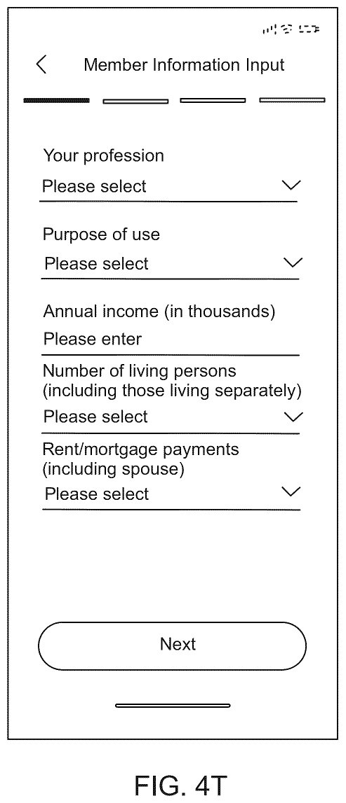

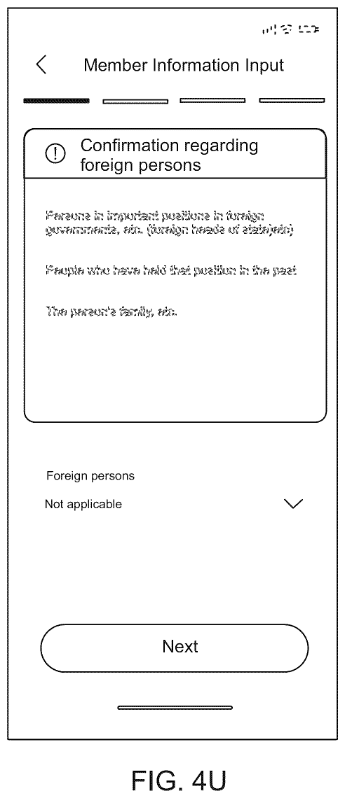

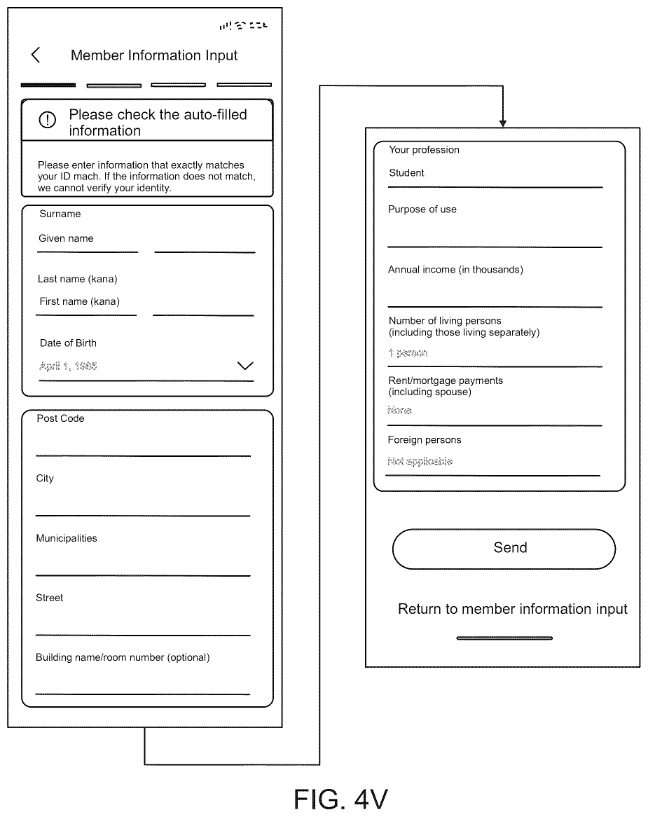

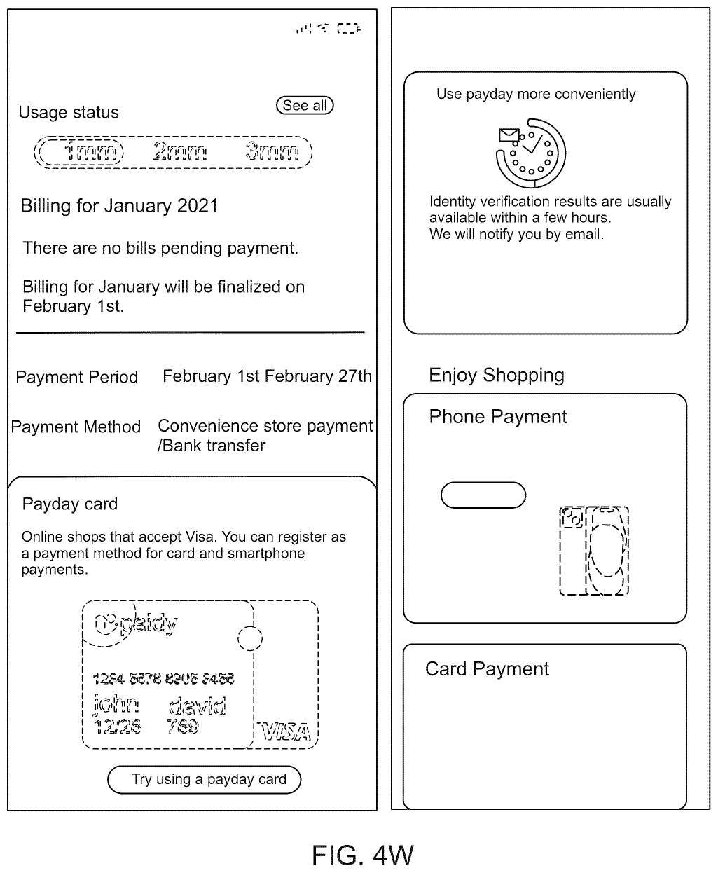

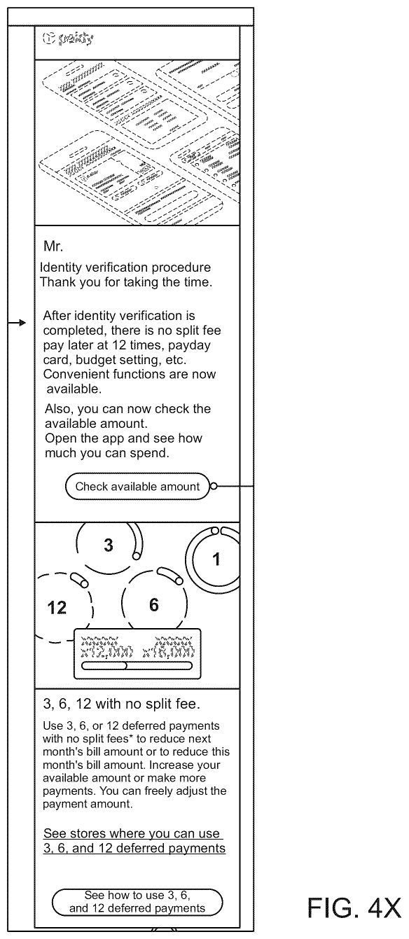

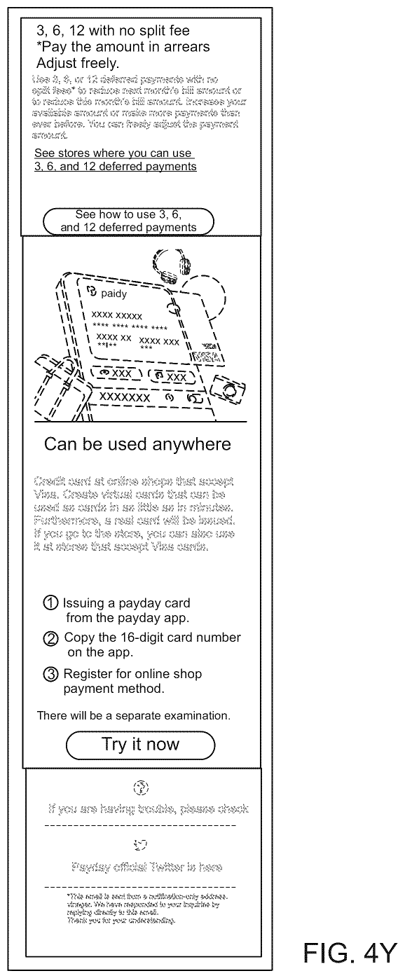

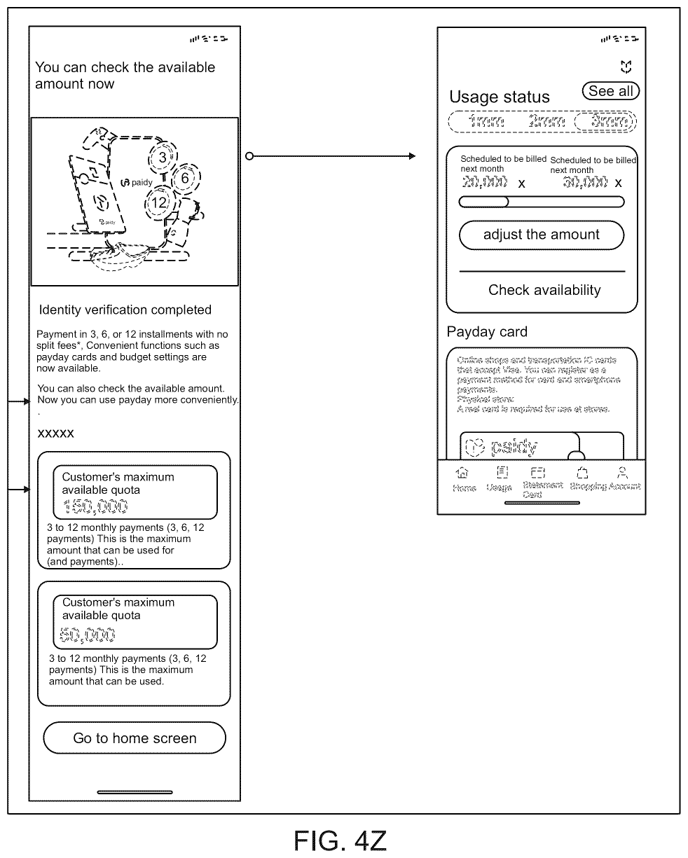

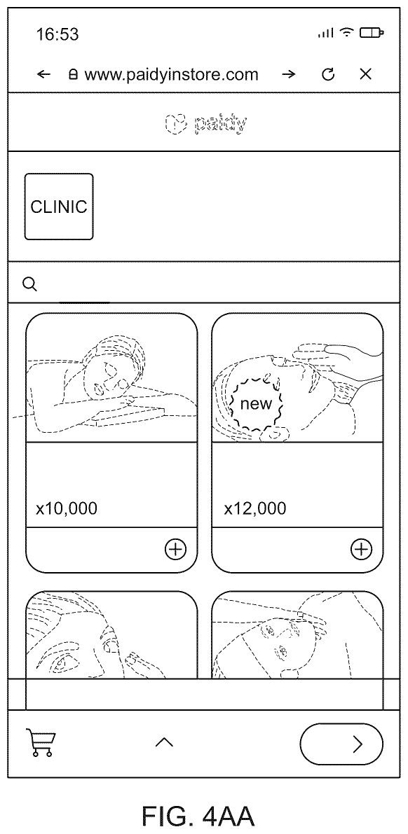

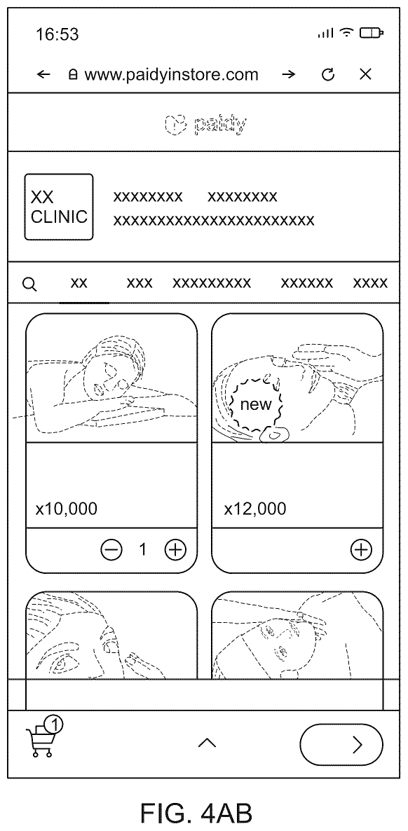

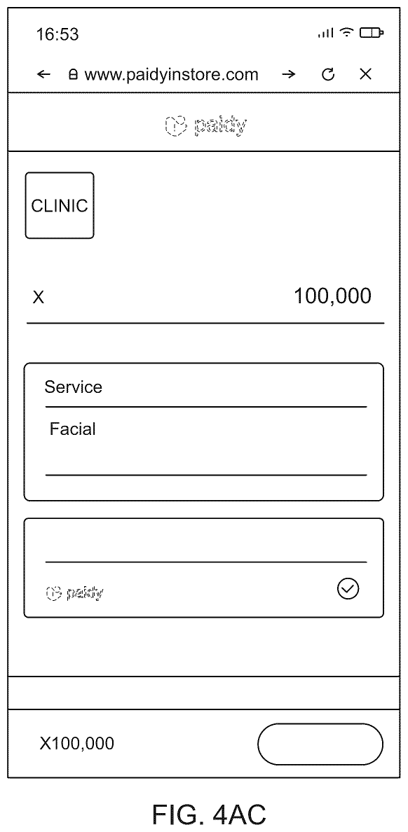

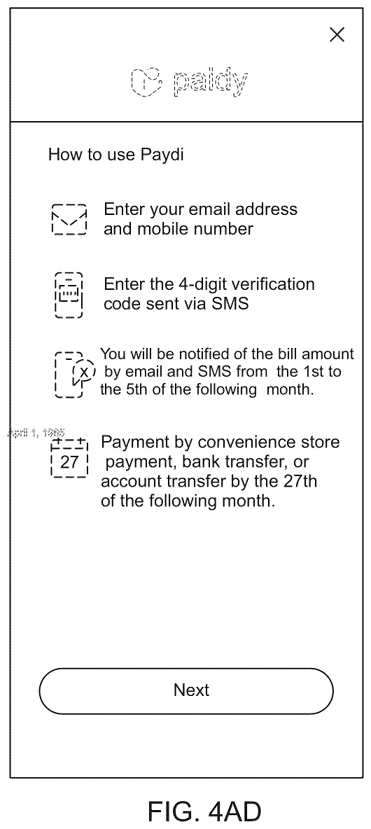

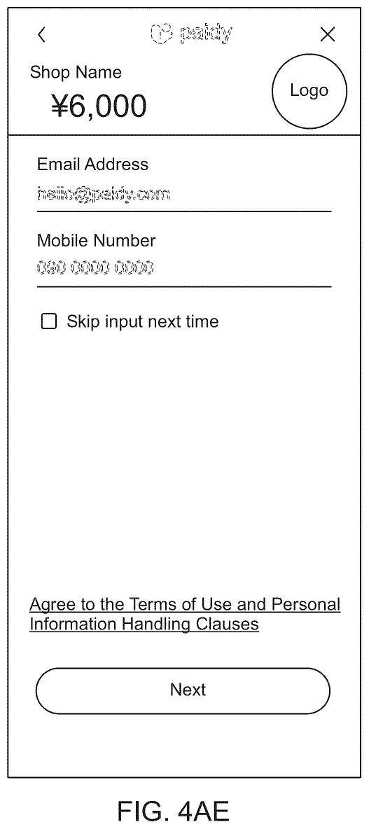

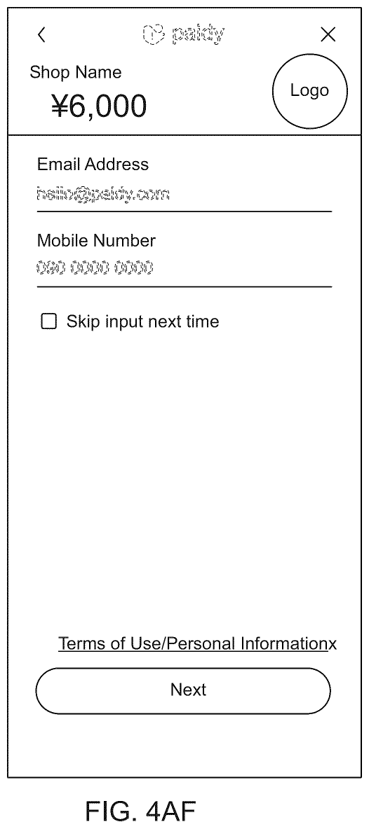

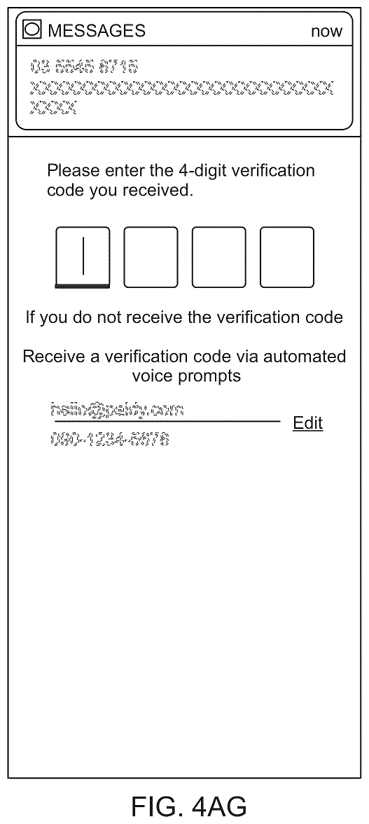

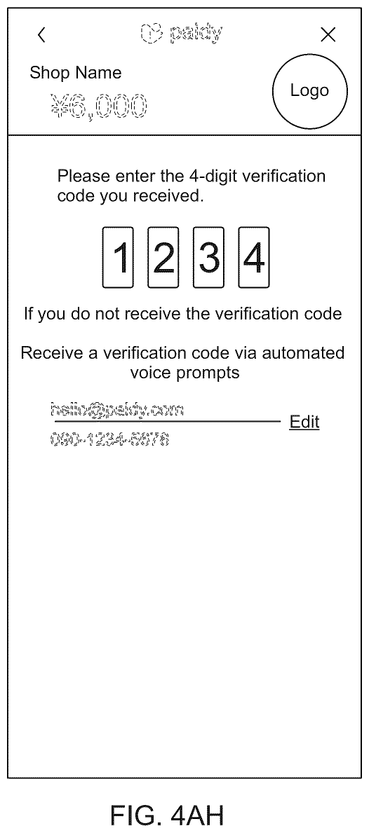

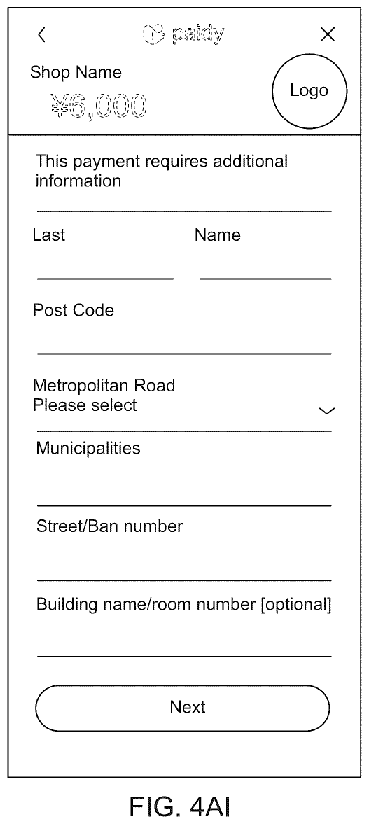

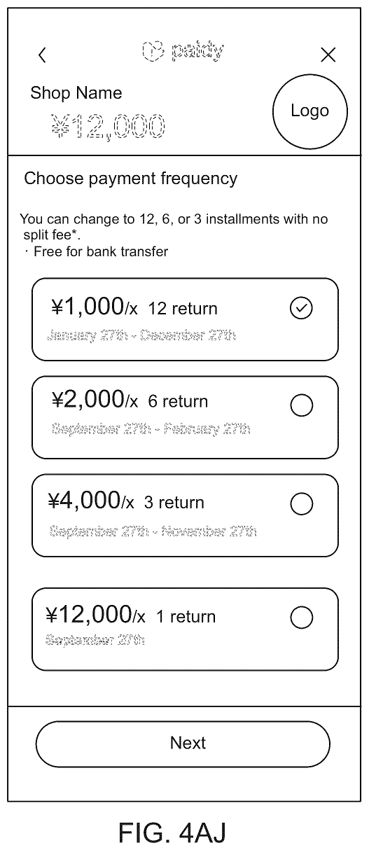

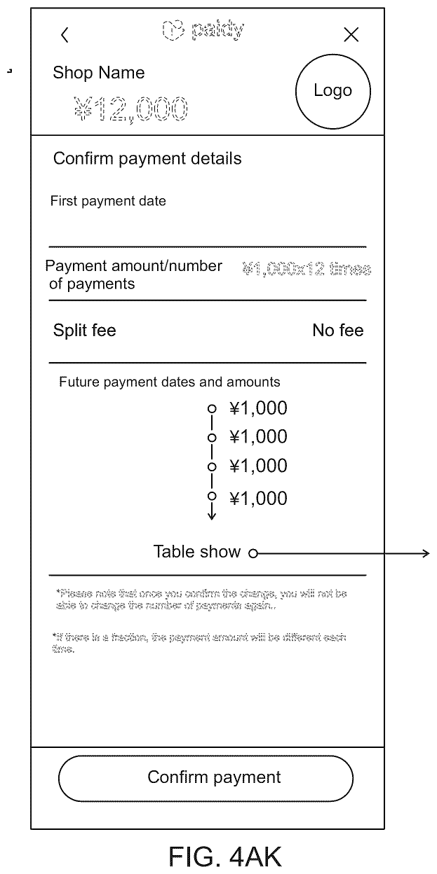

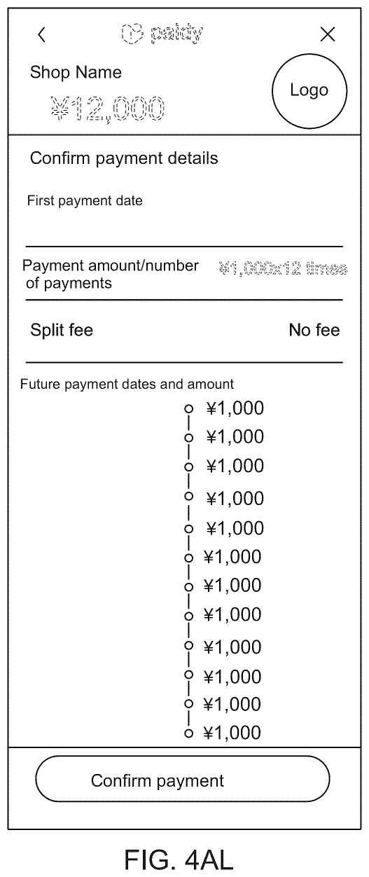

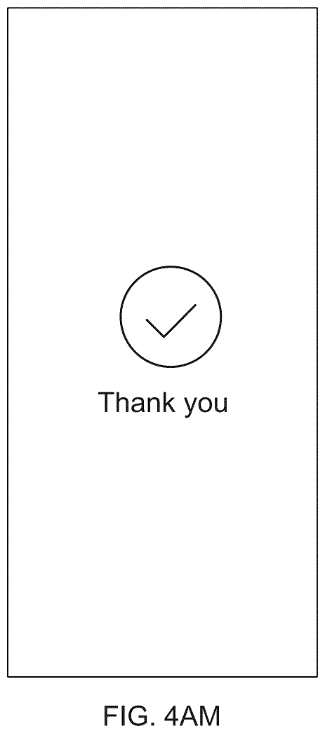

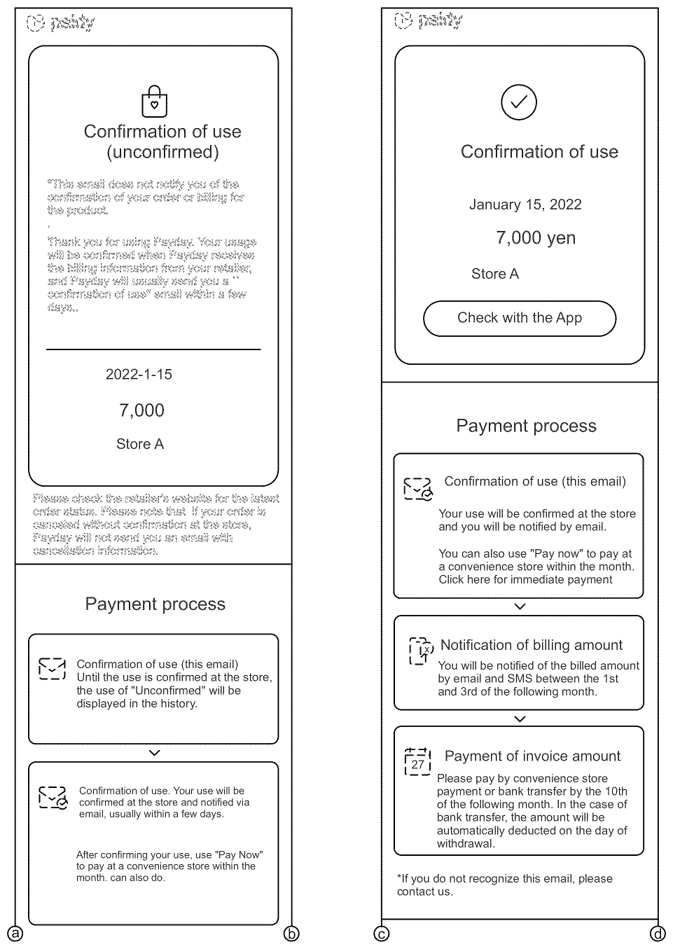

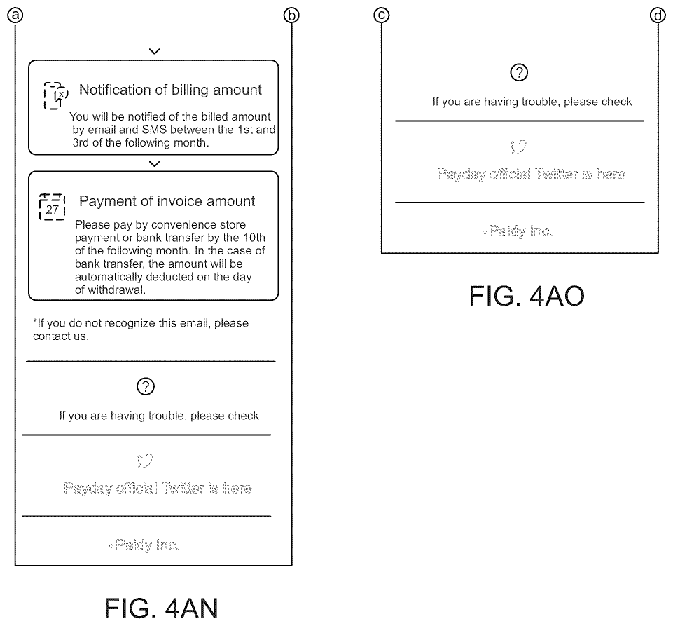

FIGS. 4A-4AO are exemplary diagrams and user interfaces that provide guided user data flows for spending limits and merchant checkout processes based on feature flag tracking from discovery interactions and checkout entry points, according to embodiments. FIGS. 4A-4AO show different merchant entry points for users to discover and interact with at offline merchant locations and/or with online merchants and merchant websites. In this regard, on interaction with the different merchant entry points, a user on their computing device may be directed to a feature flag for account setup and/or verification in a “Plus” application flow or guided user data flow that verifies user data, including KYC data. The interfaces in FIGS. 4A-4AO further show a user data flow where a user may enter user data to become verified and receive a spending limit, which may be streamlined and simplified for a particular merchant and based on the referral flag or other feature flag retrieved by an application SDK. Once verified, the user interface further shows a merchant checkout process and interface specific to a merchant corresponding to the initial entry point and interaction.

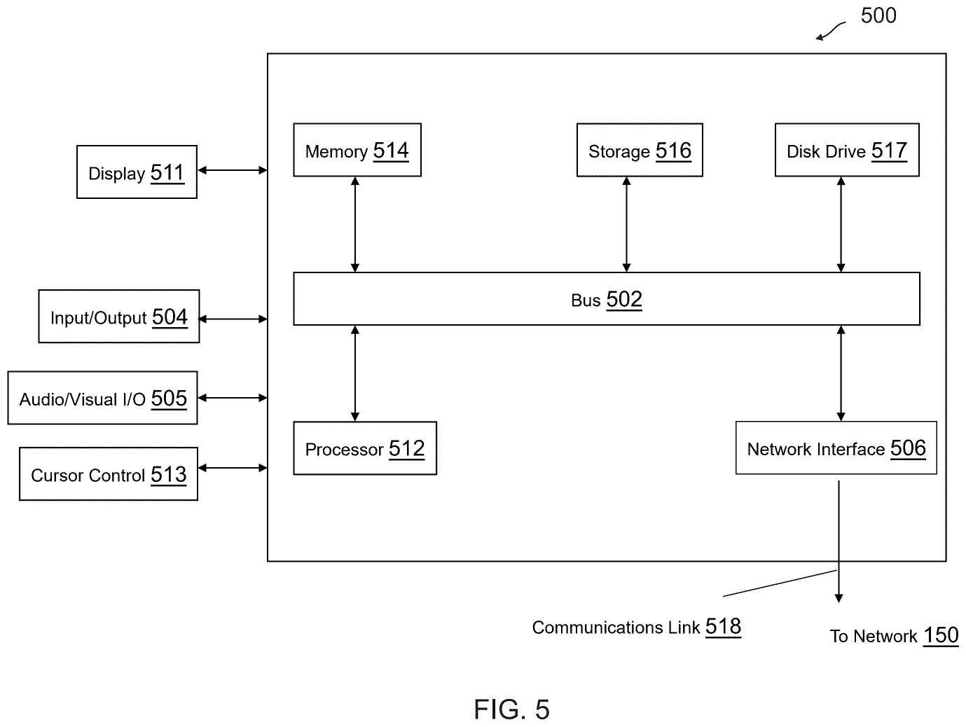

FIG. 5 is a block diagram of a computer system 500 suitable for implementing one or more components in FIG. 1, according to an embodiment. In various embodiments, the communication device may comprise a personal computing device (e.g., smart phone, a computing tablet, a personal computer, laptop, a wearable computing device such as glasses or a watch, Bluetooth device, key FOB, badge, etc.) capable of communicating with the network. The service provider may utilize a network computing device (e.g., a network server) capable of communicating with the network. It should be appreciated that each of the devices utilized by users and service providers may be implemented as computer system 500 in a manner as follows.

Computer system 500 includes a bus 502 or other communication mechanism for communicating information data, signals, and information between various components of computer system 500. Components include an input/output (I/O) component 504 that processes a user action, such as selecting keys from a keypad/keyboard, selecting one or more buttons, image, or links, and/or moving one or more images, etc., and sends a corresponding signal to bus 502. I/O component 504 may also include an output component, such as a display 511 and a cursor control 513 (such as a keyboard, keypad, mouse, etc.). An optional audio input/output component 505 may also be included to allow a user to use voice for inputting information by converting audio signals. Audio I/O component 505 may allow the user to hear audio. A transceiver or network interface 506 transmits and receives signals between computer system 500 and other devices, such as another communication device, service device, or a service provider server via network 150. In one embodiment, the transmission is wireless, although other transmission mediums and methods may also be suitable. One or more processors 512, which can be a micro-controller, digital signal processor (DSP), or other processing component, processes these various signals, such as for display on computer system 500 or transmission to other devices via a communication link 518. Processor(s) 512 may also control transmission of information, such as cookies or IP addresses, to other devices.

Components of computer system 500 also include a system memory component 514 (e.g., RAM), a static storage component 516 (e.g., ROM), and/or a disk drive 517. Computer system 500 performs specific operations by processor(s) 512 and other components by executing one or more sequences of instructions contained in system memory component 514. Logic may be encoded in a computer readable medium, which may refer to any medium that participates in providing instructions to processor(s) 512 for execution. Such a medium may take many forms, including but not limited to, non-volatile media, volatile media, and transmission media. In various embodiments, non-volatile media includes optical or magnetic disks, volatile media includes dynamic memory, such as system memory component 514, and transmission media includes coaxial cables, copper wire, and fiber optics, including wires that comprise bus 502. In one embodiment, the logic is encoded in non-transitory computer readable medium. In one example, transmission media may take the form of acoustic or light waves, such as those generated during radio wave, optical, and infrared data communications.

Some common forms of computer readable media includes, for example, floppy disk, flexible disk, hard disk, magnetic tape, any other magnetic medium, CD-ROM, any other optical medium, punch cards, paper tape, any other physical medium with patterns of holes, RAM, PROM, EEPROM, FLASH-EEPROM, any other memory chip or cartridge, or any other medium from which a computer is adapted to read.

In various embodiments of the present disclosure, execution of instruction sequences to practice the present disclosure may be performed by computer system 500. In various other embodiments of the present disclosure, a plurality of computer systems 500 coupled by communication link 518 to the network (e.g., such as a LAN, WLAN, PTSN, and/or various other wired or wireless networks, including telecommunications, mobile, and cellular phone networks) may perform instruction sequences to practice the present disclosure in coordination with one another.

Where applicable, various embodiments provided by the present disclosure may be implemented using hardware, software, or combinations of hardware and software. Also, where applicable, the various hardware components and/or software components set forth herein may be combined into composite components comprising software, hardware, and/or both without departing from the spirit of the present disclosure. Where applicable, the various hardware components and/or software components set forth herein may be separated into sub-components comprising software, hardware, or both without departing from the scope of the present disclosure. In addition, where applicable, it is contemplated that software components may be implemented as hardware components and vice-versa.

Software, in accordance with the present disclosure, such as program code and/or data, may be stored on one or more computer readable mediums. It is also contemplated that software identified herein may be implemented using one or more general purpose or specific purpose computers and/or computer systems, networked and/or otherwise. Where applicable, the ordering of various steps described herein may be changed, combined into composite steps, and/or separated into sub-steps to provide features described herein.

The foregoing disclosure is not intended to limit the present disclosure to the precise forms or particular fields of use disclosed. As such, it is contemplated that various alternate embodiments and/or modifications to the present disclosure, whether explicitly described or implied herein, are possible in light of the disclosure. Having thus described embodiments of the present disclosure, persons of ordinary skill in the art will recognize that changes may be made in form and detail without departing from the scope of the present disclosure. Thus, the present disclosure is limited only by the claims.

What is claimed is:

1. A method comprising:
receiving, by a mobile device of a user, a discovery interaction of a merchant by the user through a merchant checkout process associated with the merchant, wherein the merchant checkout process is facilitated using a transaction processor;
populating a feature flag on the mobile device based on the discovery interaction, wherein the feature flag is associated with a referral by the merchant to the transaction processor;
determining whether the user has a mobile application and an account associated with the transaction processor;
directing the user to one of a plurality of account processes for a verification of user data based on whether the user has the mobile application and the account, wherein at least some the plurality of account processes require a different amount of the user data for the verification, and wherein the verification is associated with providing a spending limit to the user with the merchant;
receiving the user data for the verification via the one of the plurality of account processes;
transmitting the user data and the feature flag to a risk engine of the transaction processor;
receiving a decision associated with the spending limit from the transaction processor based on the risk engine processing the user data and the feature flag; and
displaying the decision in a checkout interface of the mobile application for the merchant checkout process, wherein the checkout interface is specific to the merchant.

2. The method of claim 1, further comprising:
receiving, via the checkout interface, an electronic transaction processing request for a transaction with the merchant via the merchant checkout process;
determining whether the transaction violates the spending limit; and
requesting that the transaction processor process the electronic transaction processing request for the transaction based on at least one of the spending limit or an additional balance available to the user.

3. The method of claim 1, wherein it is determined that the user does not have the mobile application and the account, and wherein the directing the user to the one of the plurality of account processes comprises:
redirecting a user interface of the mobile device to an application download of the mobile application; and
in response to downloading and executing the application, opening the mobile application to a login interface or an account establishment interface.

4. The method of claim 1, wherein the discovery interaction is associated with a merchant entry point for the merchant checkout process, and wherein the merchant entry point comprises one of a physical document at a merchant location for the merchant, a quick response (QR) code corresponding to the merchant, a weblink associated with the merchant, or a mobile merchant website for the merchant.

5. The method of claim 4, wherein the user data is associated with know your customer (KYC) data utilized to determine the decision, and wherein the decision comprises one of a credit determination or an underwriting decision associated with the spending limit that is determined based on the KYC data and the merchant entry point.

6. The method of claim 5, wherein the KYC data utilized to determine the decision comprises a subset of a standardized set of KYC data used by the risk engine for decisions associated with different spending limits offered to users of the transaction processor.

7. The method of claim 1, wherein the plurality of account processes comprises a first account process for an account establishment of the account, a second account process for an account upgrade of the account to a KYC verified account, and a third account process to login to the KYC verified account when the account upgrade for the account was previously completed.

8. A system comprising:
a non-transitory memory; and
one or more hardware processors coupled to the non-transitory memory and configured to execute instructions to cause the system to:
receive, from a mobile device of a user, a request for a feature flag associated with a referral by the merchant to a transaction processor corresponding to the system;
retrieve linked data for the feature flag, wherein the linked data is associated with an indication of a discovery interaction of a merchant performed by the user for a merchant checkout process associated with the merchant, wherein the request is received responsive to the discovery interaction on the mobile device;
transmit the linked data to the mobile device;
receive, from the mobile device, user data for a verification of the user for a spending limit usable via the merchant checkout process;
determine, using a risk engine, a decision associated with the spending limit based on the user data and the feature flag; and
cause to be displayed, in an application on the mobile device, the decision via a checkout interface of the application for the merchant checkout process, wherein the decision and the checkout interface are specific to the merchant.

9. The system of claim 8, wherein determining the decision comprises:
executing the risk engine of the system based on the user data and the feature flag, wherein the user data includes a subset of know your customer (KYC) data utilized specifically for the merchant checkout process and received from the mobile device based on the feature flag and transmitting the linked data; and
computing the spending limit available to the user with the merchant based on the executing.

10. The system of claim 8, wherein the data associated with at least one of the discovery interaction or the feature flag is associated with the user for determining the decision and causing the decision to be displayed via the checkout interface.

11. The system of claim 8, wherein executing the instructions further cause the system to:
receive a request to process a transaction with the merchant through the merchant checkout process; and
determine whether the transaction complies with the spending limit.

12. The system of claim 11, wherein executing the instructions further cause the system to:
process the transaction based on determining that the transaction complies with the spending limit.

13. The system of claim 8, wherein the merchant checkout process is provided via a merchant point-of-sale (POS) device that interacts with the mobile device at a merchant location.

14. The system of claim 8, wherein executing the instructions further cause the system to:
provide information associated with one or more items for purchase through the merchant checkout process to the mobile device.

15. A non-transitory machine-readable medium having stored thereon machine-readable instructions executable to cause a machine to perform operations comprising:
detecting a discovery interaction of a merchant by a mobile device of a user through a merchant checkout process associated with the merchant;
populating a feature flag on the mobile device based on the discovery interaction;
determining whether the user has a mobile application and an account associated with a transaction processor usable to process a transaction through the merchant checkout process;
providing, via the mobile device, one of a plurality of account processes for a verification of user data based on whether the user has the mobile application and the account, wherein at least some the plurality of account processes require a different amount of the user data for the verification, and wherein the verification is associated with providing a spending limit to the user with the merchant;
receiving the user data for the verification via the one of the plurality of account processes;
determining a decision associated with the spending limit using a risk engine of the transaction processor and based on the user data and the feature flag; and
displaying the decision in a checkout interface of the mobile application for the merchant checkout process, wherein the checkout interface is specific to the merchant.

16. The non-transitory machine-readable medium of claim 15, wherein the operations further comprise:
receiving a request to obtain the spending limit from the transaction processor for use with the merchant; and
providing the spending limit via the account.

17. The non-transitory machine-readable medium of claim 16, wherein the operations further comprise:
receiving a request to process the transaction using the spending limit via the mobile application; and
processing the transaction with the merchant via the merchant checkout process.

18. The non-transitory machine-readable medium of claim 15, wherein the user data is associated with know your customer (KYC) data utilized to determine the decision, and wherein the decision comprises one of a credit determination or an underwriting decision associated with the spending limit that is determined based on the KYC data and the discovery interaction.

19. The non-transitory machine-readable medium of claim 15, wherein the plurality of account processes include at least one of an account establishment process or a KYC verification process.

20. The non-transitory machine-readable medium of claim 15, wherein the feature flag is associated with a referral by the merchant to the transaction processor.
